(19) United States
(12) Patent Application Publication
(10) Pub. No.: US 2007/0286781 A1
(43) Pub. Date: Dec. 13, 2007

(54) Process to prepare mixed molded precursor material to obtain carbides, nitrites, and sulfides

(75) Inventors: Jose Augusto Jorge Rodrigues, Lorena (BR); Victor Luis Dos Santos Teixeira Da Silva, Rio de Janeiro (BR); Marisa Aparecida Zacharias, Lorena (BR); Carlos Alexandre Miglioli, Resende (BR); Jose Luiz Zotin, Rio de Janeiro (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. - PETROBRAS, Rio de Janeiro (BR)

(21) Appl. No.: 11/785,416

(22) Filed: Apr. 17, 2007

(30) Foreign Application Priority Data
Apr. 17, 2006 (BR) PI 0601405-4

(51) Int. Cl. C01B 21/06

(52) U.S. Cl. 423/1; 423/351; 423/440

(57) ABSTRACT

A process to prepare multi-metal materials based on transition metals, using co-precipitation of mixed compound from solutions containing the metals, more specifically a process to prepare multi-metal materials based on transition metals, using co-precipitation, preferably seeking a condition of formation of a gel, from the mixture of precursor solutions containing the metals. The parameters of the process are set in such a way that the material is able to be molded by extrusion, obtaining extruded material with superior physico chemical properties, which may be used as an adsorbent, a catalyst or catalyst support, or even as filler in the reactor or column.

### CROSS REFERENCE TO RELATED APPLICATION

This application is based upon, claims the benefit of, priority of, and incorporates by reference, the contents of Brazilian Patent Application No. PI 0601405-4 filed Apr. 17, 2006.

### FIELD OF THE INVENTION

This invention deals with a process to prepare multi-metal materials based on transition metals, using co-precipitation of mixed compounds derived from solutions containing the metals. The technique of co-precipitation under the conditions conducted in this invention allows material to be molded by extrusion, resulting in “pellets” with superior physicochemical properties. They may be used as an adsorbent, catalyst precursor material, catalyst or catalyst support, or even as inert filler in the reactor or column. In particular, the materials are used as precursors to catalysts in hydrotreatment processes of oil streams, most specifically for the hydrotreatment of gas-oil.

### BACKGROUND OF THE INVENTION

The new fuel specifications, regarding the reduction of sulfur, aromatics content and olefins, have lead to a search for more active and selective catalysts for the hydrotreatment processes for fuels. These catalysts aimed at operating conditions more soft in existing units, minimizing operational costs and increasing the working life of these units, or projects that use lower pressure and volumes of reactors, reducing the investment in new facilities.

Among the various lines of development for catalysts, the use of carbides or metal nitrides has shown promise, mainly for processing of streams containing low sulfur levels.

Carbides and metal nitrides may be defined as metal compounds containing carbon or nitrogen in the interstices of the metal grid. In addition to possessing metallurgical properties, such as hardness and exceptional mechanical strength, these materials also have interesting catalytic properties. Such properties were revealed mainly during the 1960's by researchers in the Boudart et al group (R. B. Levy, M. Boudart, Science 181, 1973, 547), who showed that materials like molybdenum carbide and tungsten carbide possess catalytic properties that vary quite a bit from corresponding metals and are similar to those presented by the noble metals, such as platinum, palladium and rhodium, which are all elements much more expensive.

The application of these materials in hydrotreatment reactions has been revealed by several researchers, in open literature as well as in patent literature, such as, for example, the American patents: U.S. Pat. No. 4,271,041 (Boudart et al), U.S. Pat. No. 4,325,842 and U.S. Pat. No. 4,325,843 (Slaugh et al), U.S. Pat. No. 5,451,557 and U.S. Pat No. 5,573,991 (Sherif). These works show the potential of these carbide and nitride catalysts in the hydrotreatment of oil streams, such as gasoline, kerosene, and diesel, showing, in many cases, higher activity than the conventional catalysts of metal sulfides notably, mixed sulfides of nickel and molybdenum or cobalt and molybdenum for hydro treating.

Most papers have shown good results by using carbides or nitrides of a single transition metal, normally molybdenum or tungsten, having reports on mixed carbides containing cobalt or nickel in association with molybdenum or tungsten, as an example of the formulation of the metal sulfide catalysts.

The disadvantage of the use of carbides and nitrides is the relatively severe synthesis conditions—they are normally used at temperatures above 600 or 700° C., besides these materials possess a pyrophoric nature when exposed to air.

The severe synthesis conditions can be bypassed, according to the U.S. Pat. No. 4,515,763, using a stage called “passivation”, during which the catalyst material is exposed to low levels of oxygen, followed by an “in situ” process of reactivation by hydrogen treatment. This reactivation treatment, however, does not recover the total initial activity, as was demonstrated in several papers.

Another difficulty in employing these materials consists on its format/formation/molding. For industrial use, catalysts should be supplied in defined sizes and shapes, in order to provide the proper size for reactors regarding the flow of reagent streams, and with physical properties, such as mechanical resistance to compression and friction, and textures, as well as volume and pore diameters, which should be suitable for good performance as a catalyst. These properties are strongly influenced by the formatting method. U.S. Pat. No. 5,200,060 (Sajkowski et al) states that catalysts that are in spherical or extruded form, with a diameter in the range of between 0.02 to 0.2 cm, give good results in terms of contact with the hydrocarbon load, in fixed bed reactors as well as in processes that use expanded beds.

Regarding the format of catalysts, the U.S. Pat. No. 4,977,123 (Flytzani-Stephanopoulos et al) describes an extrusion method of mixed metal oxides which results in catalysts that combine a high specific area and good mechanical strength. Related work in the literature does not specify a formatting process for carbides and nitrides in application in HDT reactions.

Recently, Rodrigues et al developed a method for the preparation of molybdenum and tungsten carbides and nitrides, all extruded, to be used in the aerospace sector, as an hydrazine decomposition catalyst. This method involves preparation of a molybdenum or tungsten precursor compound, which is extruded in suitable conditions, followed by heat treatment and, finally, carburization, in the presence of a mixture of hydrogen and methane, or nitridization in the presence of ammonia. The catalyst, obtained in this way, has a suitable mechanical strength for space use. (Catalysis Letters, Vol. 45,1-3,1997).

Recently, Oyama et al (C. C. Yu, S. Ramanathan, B. Dhandapani, J. G, Chen, S. T. Oyama, J. Phys. Chem., 8101, 1997, 512) also describe the use of bimetal carbides for hydrotreatment reactions, in particular, the mixed carbide of molybdenum and niobium, which is considered superior to single carbides and to conventional hydrotreatment catalysts. The authors used the synthesis method called “solid-state reaction” that consists on heating the oxides of the two metals at a high temperature, in order to obtain a mixed oxide of molybdenum and niobium, followed by a carburization stage. Due to the high temperatures used during synthesis of mixed oxides, always above 700° C., the material sinters, a phenomenon that hinders in obtaining the proper rheological properties in its formation/structure; particularly for obtaining pellets by extrusion, method that is used in the preparation of hydrotreatment catalysts, when production in industrial scale is expected to be done on an industrial scale. The difficulty of peptization (physicochemical process responsible for the union of the metal precursor particles in the extrusion process) becomes necessary to add binding agents at high concentration, which may cause contamination and/or reduction of the level of active material present in the catalyst.

The use of catalysts from transition metal sulfide has been extensively known for hydrotreatment of oil streams. Catalysts prepared from mixed molybdenum or tungsten sulfides with nickel or cobalt, supported in alumina, silica-alumina and alumina-zeolite are widely used in industrial application. The use of unsupported systems (mass catalysts) based on metal sulfides, however, were restricted to standard systems and academic studies due to the low surface area and, consequently, low catalytic activity provided by conventional methods of preparation of these solids.

An alternative for obtaining molded mixed oxides, for example, by extrusion, consists on the method described by Pechini in U.S. Pat. No. 3,330,697—“Method of preparing lead and alkaline earth titanates and niobates and coating method using the same to form a capacitor”. This method involves the organic chelate formation of precursor metals, followed by polymerization and thermal decomposition. By properly controlling the water content in the product, extruded compounds of these materials may be obtained for later nitridization or carburization. In spite of producing a material with good properties, one disadvantage to this method is the fact that it uses organic agents, such as citric acid or ethylene glycol, which makes the production process more expensive, eventually generating waste, principally carbon, in the extruded material.

### SUMMARY OF THE INVENTION

This invention proposes an advance in the preparation of multi-metal catalysts made of carbides and nitrides and sulfides of mixed transition metal, providing an alternative to the “solid-state reaction” method of synthesis for precursors.

The final product, in extruded form, has textural and mechanical properties superior to those obtained by the known techniques in the state of the art, such as, better catalytic activity for hydrotreatment reactions.

This invention also proposes a methodology to preserve original activity of the catalyst after the carburization or nitridization stage, with this, avoiding the passivation stage with oxygen, said stage, in accordance with mentioned above, definitely compromises the catalytic activity of the material.

The process proposed by this invention has advantages which mainly consist on using moderate temperatures and release the use of organometallic reagents and solvents in large quantities.

Another advantage is the addition of facilitating agents for structure, such as organic agents and inert material. The technique employed by the process now proposed makes the addition of these materials unnecessary.

This and other advantages will become evident for specialists in the subject as the process of the invention is described below.

This invention deals with a process to prepare multi-metal materials based on transition metals, using co-precipitation of mixed compound derived from solutions, generally from inorganic salts, which contain the metals involved in synthesis. The process of co-precipitation is conducted in such a way that the material is able to be molded by extrusion, resulting in “pellets” with superior physicochemical properties. They may be used as an adsorbent, catalyst precursor material, catalyst or catalyst support, or even as filler of reactor or column.

The process consists on a mixture, under stirring, containing two or more solutions of the salts of the above mentioned metals in controlled conditions of temperature, pH, concentration of metals and addition time, until a precipitate is formed. In the following stage, the material is filtered or put into a centrifuge to obtain a moist paste, which presents an amorphous structure by X-Ray Diffraction after drying. The conditions of temperature, pH, concentration of metals and the addition time may vary in accordance with the salts and metals chosen for the preparation.

The paste obtained may be dried, for removing the moisture, or processed directly. In both cases, the solid separated in the former stages is peptized and redispersed, by action of an acid or base agent, in order to obtain a suspension with binding properties is obtained. The humidity level in this stage is adjusted in accordance with the formatting process that will be used.

The multi-metallic material, thus obtained, presents rheological properties suitable for extrusion molding and morphological properties that facilitate the transformation stages of these materials into carbides, nitrides, and sulfides. These properties are not obtained by processes now known in the state of the art.

### DETAILED DESCRIPTION OF THE INVENTION

The materials described in this invention are multi-metallic, containing at least one transition metal, in which the metallic elements are homogeneously distributed and dispersed, and they are obtained, in general, from inorganic salts that result, after calcination, in mixed metal oxides.

In general terms, the process proposed by this invention includes the following stages:
a) mix, under stirring, at least two solutions prepared by the dissolution of soluble compounds of metals, in which at least one is a transition metal, under controlled conditions of temperature, pH, metal concentration, and addition time, set in function of involved metals, until a formation of a precipitate occurs, and in some cases the age of a precipitate;
b) adjust, in some cases, the pH of the reaction medium for the action of an inorganic acid or basic agent, added to the reaction medium in order to accelerate the co-precipitation stage;
c) filter and/or to centrifuge the precipitate in order to obtain a moist paste that provides conditions for molding;
d) peptize and to redisperse the solid in an acid or basic agent in order to obtain a suspension with binding properties;
e) eliminate the excess of moisture from the solid obtained and formatting it in accordance with the chosen technique, preferably by extrusion;
f) dry and to calcine the formatting solid, according to a program selected temperature, established in function of the metals present in the precursor, in order to obtain a mixed metal oxide ready to be carburized, nitrided or sulfided.
g) expose the mixed metal oxide to a treatment stream that directs it to form a mould mixed carbide, a mould mixed nitride, or a molded mixed sulfide; and
h) store mould carbides and nitrides in an organic compound that is liquid or solid at room temperature.

In accordance with the process of this invention, in order to obtain the compounds, first, the precursor solutions containing the metals of the desired mixed oxide is prepared for the mixed oxide desired. In a preferred implementation, inorganic salts precursors of the mixed oxide desired are used. These solutions are mixed by stirring, under controlled conditions of temperature, pH, and time of mixing, promoting the formation of a precipitate, where the final product of this stage is a precursor suspension of the desired oxide.

In the preferred implementation, the suspension takes the form of an inorganic gel.

The suspension thus obtained, is kept under stirring, in a period of some minutes up to 24 hours, preferably from a few minutes to 2 hours, in a period of maturation during which the precipitation reactions will take place. In the preferred implementation, the temperature is maintained at around 5° C. and the pH of the suspension should be controlled, preferably within the range of 2.8 and 3.3. In the preferred implementation, the temperature and the pH of the suspension are the same as the precipitation stage.

Metal oxide precursors are useful in this invention, such as nitrate, chloride, carbonate, phosphate, sulfate, and oxalate salts of the selected metals, but not limited to these examples. Metal oxide precursors where the metal is in the form of an anionic complex are equally useful, such as molybdates, niobates, chromates, but not limited to these examples.

In the preferred implementation, after mixing the solutions, the pH of the reaction medium needs to be adjusted by the addition of an acid or basic agent, in order to favor the co-precipitation of the multi-metal precursors. In this case inorganic acids or bases are useful, but not limited to these examples.

The solids may be separated from the suspension obtained in the former stage by decanting, filtering, under vacuum or with the help of a press type of filter, or centrifuge, but not limited to these examples.

The solid thus obtained contains the precursor of the mixed oxide desired in the form of a paste, which is dried in the presence of air, at a temperature between 40 and 300° C., preferably between 40 and 150° C.

Preferably, the dry material should possess an amorphous crystalline structure under X-Ray Diffraction, indicating a good dispersion and interaction of the metals in the compound obtained. The compound thus prepared, but not molded, may be air calcined, at temperatures between 100 and 1000° C., preferably between 200 and 600° C., in such a way to decompose the precursors and to supply the desired mixed oxides.

In the applications requiring molding, one possibility consists on redispersing the dry material by adding water and a solution containing a peptizing agent, in such a way to form a paste with rheological binding properties and that provides proper conditions for formatting. Formatting should be understood as the processes of extrusion, chipping, spray-drying, oil drop, spherization, but not limited to these examples.

Other possibility consists on adjust the level of moisture in the moist paste obtained after filtration, without going through the drying stage, and to add a solution of peptizing agent, to make a paste with binding properties, which supplies proper conditions for formatting.

The formatted material must be dried at temperatures between 40° C. and 300° C., preferably between 40° C. and 150° C., followed by air calcination, at temperatures between 100° C. and 1000° C., preferably between 200° C. and 600° C., in such a way to decompose the precursors and to provide forming the desired mixed oxides.

The material then obtained is ready to be used as a catalyst, catalyst support, catalyst precursor, adsorbent or inert filler for the reactor or column.

The solid material obtained in accordance to the procedure previously described, may be carburized, to form the respective metal carbide, or nitrided, to obtain the respective metal nitride, or even sulphided, to obtain the corresponding metal sulphide.

In the carburization stage, the solid is submitted to a reaction with a carbon precursor in a reducing atmosphere. Hydrocarbons may be used as a source of carbon, such as the alkanes, preferably methane, cycloalkanes, oil streams, but not limited to this example. As a reducing agent, hydrogen, carbon monoxide or a mixture of both may be used.

In this stage, the solid is heated at a controlled heating rate, in the presence of the carburization mixture, up to the temperature that is a function of the metals present in the precursor of the desired mixed oxides, maintaining this temperature for at least 1 hour. For example, the final carburization temperature for molybdenum-niobium oxides is found within the range between 400° C. and 900° C., preferably between 500° C. and 800° C.

The solid obtained in this way has the typical properties of metal carbides.

Nitrided is conducted in a similar manner, using ammonia as a source of nitrogen, instead of using a hydrocarbon compound.

Sulfated is conducted in a similar way, using as a sulfating agent compound containing sulfur, such as for example, hydrogen sulfide, dimethyl-disulfide, and organic polysulfides, pure or dissolved in a hydrocarbon stream in the presence of hydrogen.

The solid materials thus obtained are suitable for use as catalysts in hydro processing reactions, such as the removal of organic sulphurized compounds (hydrodesulphurization—HDS), removal of organic nitrogenized compounds (hydrodenitrogenization—HNS), removal of unsaturated and aromatic compounds (hydrogenation—HD), and the conversion of heavy compounds in lighter fractions (hydrocracking—HCC).

Such reactions are applied to hydrocarbon streams within the following ranges: Naphta, kerosene, gas-oils, heavy and waste gas-oils.

In the case of newly synthesized mixed carbides and nitrides, in order to preserve their catalytic properties and avoid passivation processing with oxygen, they are collected in a liquid organic compound that has been pre-treated to remove any gaseous fraction that might be present. This solution containing the catalyst is tanked in an inert atmosphere. Thus, the contact of carbides and nitrides with the oxygen in the air is avoided, facilitating their handling and transportation.

Organic compounds from the classes of paraffin, isoparaffins, cycloparaffins, aromatics, polyaromatics, or combinations of these functions are useful in this operation. Heteroorganic compounds, mainly those containing sulfur and oxygen, should, in principle, be avoided in order to not contaminate the catalyst. Paraffinic compounds, containing between 6 and 60 atoms of carbon, liquids or solids, at room temperature, are particularly preferred.

The material, thus obtained, possesses superior catalytic properties for converting sulfurized, nitrogenized, and aromatic compounds from oil stream.

The use of the catalyst is done by loading it together with the protective solvent in the reaction vessel, heating them in the presence of the hydrogen stream or inert gas. Under these operational conditions, the protective solvent is expelled from the catalyst, releasing it for use in the reactors we are interested in.

The process for preparing the mixed precursors now proposed and the proper selection for the conditions in which it is conducted, allow obtaining multi metallic material based on transition metal under lower temperature conditions to those quoted in the literature, for the synthesis of similar compounds having proper rheological properties for molding. These properties allow preparing pellets of carbide, nitride, and sulfide, with mechanical strength and specifically superior to those found in the state of the art.

The examples presented below are for the purpose of illustrating the invention and facilitating understanding, and in no way restrict these.

### EXAMPLE 1

In this example, the process for preparing mixed molybdenum and niobium oxides is described as presented in the method proposed by this invention, during which it is verified the quick and intense transition from “sol” to “gel” (sol-gel) of the reaction medium.

To an aqueous solution of molybdenum, obtained by dissolving 12.8 g of ammonium molybdate in 75 mL of water, keep under stirring and cooled at temperature below 5° C., is added a pre-filtered niobium aqueous solution, obtained by dissolving 10.0 g of ammonium niobium oxalate in 160 mL of water, keep under stirring at a temperature of around 5° C. The pH of the niobium solution is between 0.8 and 1.3 and the pH of the molybdenum solution is between 4.9 and 5.3. After mixing, the solution is maintained below 5° C., with the help of an ice bath and coarse salt, while it is vigorously stirring (780-800 rpm). After about 10 minutes, it will be observed that the solution has become gradually cloudy and highly viscous while as at the same time, it is formed a white gel with a pH of between 2.8 and 3.3. The formed gel is kept in repose at room temperature and pressure for 24 hours. Then, it is isolated from the solution by vacuum filtration. This gel filtration is extremely slow (between 10 and 15 hours), and the isolated product is the precursor material of the mixed oxide.

The resulting product is dried on a stove at a temperature of approximately 60° C. for 24 hours. After this period, the vitreous, green material is crushed and sifted (0.105 mm) and, afterwards, it is submitted to molding stages and thermal treatment.

The extrusion of this material may be performed in accordance to the following procedure: a known quantity of the sifted precursor is transferred to a porcelain mortar, and, then, drop by drop a dispersal agent (H₂O, HNO₃, NH₄OH and acetic acid) is added. The addition of this agent continues until a homogeneous and consistent paste is obtained, which has the proper rheological properties for extrusion. This maceration/dispersion operation takes about one hour. Finally, the paste is transferred to a pressing device to be molded by extrusion.

The bimetallic extruded products should remain exposed to the air for 24 hours. After, it is transferred to stoves maintained at 60° C. and, later, at 120° C., in which they should be kept for 24 hours at each temperature. Finally, the bimetallic extruded compounds are calcined at 600° C. and 700° C. respectively, remaining 4 to 5 hours at specific temperature for each case. The rate of heating used is approximately 2° C. per minute. The material obtained according to this methodology presents a mechanical resistance of 8.2 N/mm. This solid shall be referred to as MoNb-SG.

### EXAMPLE 2

In this example, the preparation of mixed molybdenum and niobium oxides by the method proposed in this patent application is described. However, the thermal treatment stage was optimized in order to generate materials with larger mechanical strength.

The procedure to obtain extruded products was performed as described in Example 1. After the bimetallic extruded products were obtained, these remain exposed to the air during 24 hours. Thereafter, they are transferred to a microprocessor oven at a high temperature as programmed from room temperature up to 130° C. (approximately 0.40° C./minute), remaining for 60 minutes at 130° C., raising the temperature from 130° C. up to 700° C. at a rate of 0.75° C./min. and remaining for 5 hours at 700° C. An oxygen flow at 1200 mL/minute is introduced starting at the beginning of the treatment.

The extruded material, after this treatment, presents a mechanical resistance of 32.5 N/mm. This solid shall be referred to as MoNb-SG.

### EXAMPLE 3

In this example, the preparation of mixed molybdenum and niobium oxides by the method proposed in this patent application is described. However, the thermal treatment stage was adjusted in order to maximize the resulting mechanical strength obtained in Example 2. The procedure to obtain extruded material was performed as described in Example 1.

After obtaining the bi-metal extruded products, they should remain exposed to the air for 24 hours. Thereafter, they are transferred to a microprocessor oven at a high temperature as programmed from room temperature up to 130° C. at a rate of approximately 0.40° C./minute, remaining for 30 minutes, raising the temperature from 130° C. up to 400° C. at a rate of 0.30° C./minute and remaining at this temperature for 3.5 hours. An oxygen flow is introduced (1200 mL/minute) when the temperature reaches 400° C.

The temperature is raised from 400° C. up to 700° C. at a rate of 0.75° C./minute. This temperature is held for five hours. The extruded material, after this procedure, presents a mechanical resistance of 39.5 N/mm. This solid shall be referred to as MoNb-SG.

### EXAMPLE 4

This example shows how it is possible to control the porosity properties of the final material by adding porogenous agents, such as microcrystalline cellulose, amides, etc. This addition does not reduce the mechanical strength to values that would make the product improper for industrial application. The procedure for obtaining the extruded precursor material is performed as described in Example 1, except for the extrusion molding stage, during which approximately 5-10% amide is added to the amorphous bi-metal precursor.

After obtaining the bi-metal extruded products, they should remain exposed to the air for 24 hours. Thereafter, they are transferred to a microprocessor oven at a high temperature as programmed from room temperature up to 130° C. at a rate of approximately 0.40° C./minute, remaining for 30 minutes, raising the temperature from 130° C. up to 400° C. at a rate of 0.30° C./minute and remaining at this temperature for 3.5 hours. An oxygen flow is introduced (1200 mL/minute) when the temperature reaches 400° C. In the next stage, the temperature is raised from 400° C. up to 700° C. at a rate of 0.75° C./minute. This temperature is held for five hours. The extruded material, after this procedure, presents a mechanical resistance of 14.4 N/mm. This solid shall be referred to as MoNb-SG.

### EXAMPLE 5

In this example, the process of preparation of molybdenum, tungsten and nickel multi-metal oxides by the method (called co-precipitation) proposed in this patent application is described.

A solution of tungsten is obtained by dissolving 17.7 g of tungstenic acid (hydrated tungsten oxide) newly prepared in 110 ml of water. The dissolution is finished by adding approximately 800 ml of a 0.5% solution of ammonium hydroxide, resulting in a pH of 8.7.

Another solution is obtained by dissolving 39.2 g of nickel nitrate in 180 mL of water and 11.9 g of ammonium molybdate. Under strong stirring, a solution containing molybdenum and nickel in a tungsten solution is added. It will be observed that a light green suspension will immediately be formed, with a pH of between 6.8 and 7.0. This suspension is kept in repose for 24 hours at room temperature and pressure.

In the next stage, the precipitate is isolated from the solution by vacuum filtering, using a sintered plate funnel. The product is then dried in an oven at a temperature of approximately 60° C. for 24 hours. Right afterwards, it is crushed, granulometrically selected (0.037 mm), and submitted to molding and thermal treatment stages, as in Example 1. The product obtained is made up of a multi-metal precursor, ready to be carburized, nitrided, or sulfided.

### EXAMPLE 6

This example describes obtaining through co-precipitation at room temperature a multi-metal precursor involving the metals molybdenum and tungsten.

The molybdenum solution was prepared by the addition of 17.6 g of molybdenic acid in 135 mL of water, forming a white suspension, to which a solution of ammonium hydroxide (50%) is added slowly until a pH of 9.5 is attained, at which point total solubilization occurs. The tungsten solution was prepared by the addition of 29 g of tungstenic acid in 180 mL of water, forming a white suspension, to which a solution of ammonium hydroxide (50%) is slowly added until a pH of 9 is attained, at which point total solubilization occurs. Under strong stirring, a molybdenum solution is added to the tungsten solution, resulting in a clear solution with a pH of 9.4. To this, 284 mL of glacial acetic acid is immediately added, obtaining immediately a white suspension with a pH of 3.6. This suspension is allowed to repose for 24 hours at room temperature and pressure, and after this period is submitted to a vacuum filtering stage in a sintered plate funnel.

The product is then dried on an oven at a temperature of approximately 60° C. for 24 hours. After, it is crushed; granulometrically selected (0.037 mm), and submitted to molding and thermal treatment stages, as in Example 1. The product obtained is made up of a multi-metal precursor, ready to be carburized, nitrided, or sulfated.

### EXAMPLE 7

In this example the preparation of a mixed oxide using the method known as “solid-state reaction” as applied to the preparation of mixed carbide and nitride catalysts is described, in accordance with that described in the state of the art.

In accordance with the procedure used in the state of the art, 5.48 g of molybdenum trioxide and 3.38 g of niobium pentoxide, both in powder form, are mixed and placed in a mortar. With a pestle to use as a mechanical means of homogenization and crushing, drop by drop of ethanol is added as a chemical re-dispersion agent to the powders, until a paste is obtained that is possible to mold. This paste is transferred to an appropriate device and is pressed on a wafer form. It should be noted that it is not possible to carry out peptization of a mixture of precursor oxides, and consequently, it is also impossible to mold the substance by extrusion.

After being exposed to air for 24 hours, the wafers are dried by heating them to 60° C. and 120° C., respectively. They should also remain during 24 hours at each stage. Calcination is performed by submitting the wafers to a heating ramp of approximately 5° C./min. until the temperature of 785° C. is reached. It should be kept at this baseline for 6 hours. This solid shall be referred to as MoNb-ES.

### EXAMPLE 8

The preparation of a mixed oxide by the method called “Pechini” is described in this example, as applied to the preparation of multi-metal oxides, described in the state of the art. According to this procedure, chelates of the metal oxide precursors must be first obtained.

A citric acid solution is initially prepared, by adding 200 mL of water, under stirring and softly heating (50° C.) to 201.2 g of citric acid. After dissolution, the solution is kept under stirring, to later adding the salts of the mentioned metals. A solution of molybdenum citrate is prepared by adding 25.6 g of molybdenic acid to a citric acid solution (previously prepared), under stirring and softly heating slightly. After the molybdenum chelate is formed, 44.6 g of ammonium niobium oxalate is added. A homogeneous straw colored solution is immediately obtained. At that time, the pH of the solution is corrected to a value of 3 by adding concentrated ammonium hydroxide. After correcting the pH, 900 mL of ethylene glycol is added. Then the temperature of the reaction medium is raised to approximately 100° C., maintaining in this level until the major part of the water be removed and resulting in an homogeneous solution of low viscosity. The condensation reaction takes place at the same time the water is removed in the next stage, with moderate heating between 130° C. and 175° C., producing a highly viscous resin. Later, this resin is submitted to thermal treatments at rising temperatures.

In the first stage, the temperature is kept at approximately 290° C., for approximately 8 hours, obtaining a solid polymer resin. The total elimination of volatiles is carried out in a furnace, under a static atmosphere, at a temperature of approximately 400° C., after a period of between 8 and 12 hours. A bi-metal oxide is obtained ate 720° C., after maintaining it at this temperature for a period of between 5 and 10 hours, under a controlled oxygen atmosphere. This solid shall be referred to as MoNb-PC.

### EXAMPLE 9

The process to prepare mixed carbides from the corresponding bimetal oxides is described in this example. These precursors are obtained through the co-precipitation/sol-gel (SG), solid-state reaction (ES), and Pechini (PC) methods, and they are submitted to thermal treatments in the presence of methane and hydrogen.

The carbides were synthesized using the temperature-programmed carburization (TPC) method. The carburization consists on depositing a suitable mass of mixed oxides, which may be molded by extrusion, or pressed into wafers or in powder form, in a quartz reactor, which is linked to an experimental unit by two CAJON® type connections.

During carburization, a mixture containing 20% (v/v) of CH₄ in H₂ has its flow rate adjusted to the desired value (approximately 350 mL/min.) and the reactor temperature is linearly elevated at a constant rate from room temperature until reaching the final desired (for example, 780° C.), remaining at this temperature for 90 minutes. At the end of the isothermal period, at the final temperature of synthesis, a gaseous mixture in the reactor, or in other words, 20% (v/v) CH₄/H₂ is exchanged for pure He (50 mL/min.) and the reactor temperature is reduced to room temperature. The optimal temperature of carburization varies in function of the synthesis method and of the metals present in the multi-metal precursor.

In a general way, it is obvious that the synthesis method by “sol-gel” requires carburization temperatures nearing 50° C.; lower than the temperatures required by the rest of the preparation methods.

The materials obtained were tested in chemical reaction followed in the same synthesis reactor, avoiding contact with the atmosphere. When this was not possible, the carbide was passivated at room temperature, using, for this purpose, a mixture of 0.5% (v/y) of oxygen in He (conventional passivation procedure) and stored in a dry chamber.

Alternately, the newly prepared carbide was transferred to a dry chamber and collected in a flask containing an organic solvent, typically isooctane. The carburized solids, thus obtained, were called respectively, MoNb-SG/C, MoNb-ES/C and MoNb-PC/C.

A fourth sample was prepared from the MoNb-SG precursor, as previously referred, in the presence of NH₃, to obtain the corresponding mixed nitride. The nitrided solid was called MoNb-SG/N.

Regarding the development of mechanical strength during the carburization stage, the results indicate a reduction in the value of this property, ranging from 21 N/mm to 10 N/mm, in an experiment, and from 16 N/mm to 10 N/mm in a second experiment.

In Table 1 that follows, the specific areas of the solids obtained by the process of this invention are shown, and they are compared with values described in specialized literature, particularly by Oyama for mixed MoNb carbide, a material that is obtained through the “solid-state reaction”.

TABLE 1
Specific Area of Mixed Carbides and Nitrides.

| Sample | Method | Specific Area (m²/g) |
|---|---|---|
| Carbide: | Precursor obtained by co- | 186 |
| MoNb-SG/C | precipitation/sol-gel | |
| Carbide: | Precursor obtained by “solid- | 115 |
| MoNb-ES/C | state reaction” | |
| Carbide: | Precursor obtained by Pechini | 150 |
| MoNb-PC/C | | |
| Carbide: | Precursor obtained by “solid- | 98 |
| MoNb/C | state reaction” by Oyama et al | |
| Nitride: | Precursor obtained by co- | 191 |
| MoNb-SG/N | precipitation/sol-gel | |

Initially, it is shown that the specific area values of the materials obtained by solid-state synthesis (SS) by Oyama and in this work (Example 5) were very close, attesting the reproducibility of the process.

The values of the specific area of the mixed carbide obtained by the sol-gel method are clearly higher than the rest of the methods described in specialized literature, and particularly higher than those described by Oyama, with the advantage of being the carbide in an extruded form. The mixed oxide sample obtained by nitration prepared by the sol-gel method also showed an elevated specific area, similar to the corresponding carbide, indicating that the development of this property in carburized and nitrated materials are intimately related to the synthesis of mixed precursor oxide.

The extruded form of these materials in oxidized form, as described in Examples 1 to 8, as well as the carburized materials, as in Example 9, was submitted to crushing tests to determine their mechanical strength. This test determines the force necessary to crush the particles along their diameter, which means that the greater this value is, the greater is the strength of the material to mechanical forces, such as those applied by the weight of the catalyst itself, by the liquid retained in the spaces between the particles (“hold-up”) and by the loss of load caused by leakage.

A catalyst of low mechanical strength tends to disintegrate during their use, generating sharps and increasing the resistance to leaks inside the reactor.

As mentioned in the different Examples, materials were obtained having a mechanical strength suitable for industrial use. As a comparison, the technical literature indicates that an industrial catalyst made of mixed sulfides, such as NiMo supported in alumina, has a mechanical strength on the order of 8 N/mm, which has a lower value than found in the various materials prepared by this invention's process.

### EXAMPLE 10

In this example, the preparation of mixed sulfides from the multi-metal precursors obtained, in accordance with Example 5, is described.

The sulfides are synthesized after having the multi-metal precursor to molybdenum, tungsten, and nickel, in a reactor and, then, submitting it to a thermal decomposition stage in a nitrogen atmosphere, at a flow rate of 100 mL/min and a rate of temperature elevation of approximately 10° C./min up to the temperature reaches 300° C. It must remain at this baseline for one hour. Later, the compound formed is sulfided, in the presence of a mixture of H₂/H₂S, 10% (v/v), at a flow rate of 130 mL/min, and increasing the temperature to 400° C., at a rate of 10° C./min, remaining at this temperature for two hours.

After the sulfidation stage, the sulfide obtained is cooled to 200° C., still under the flow of the sulfided agent, when, at this point, the gaseous stream is cut off and the temperature of the reactor is reduced to room temperature.

The sulfide, thus obtained, has excellent catalytic activity in innumerable reactions present in the hydrotreatment processes.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. Process to prepare mixed molded precursor material to obtain carbides, nitrides, and sulfides, comprising:
a) mix, by stirring, at least two solutions prepared by dissolving compound solutions of two metals, in which at least one is a transition metal, under conditions of controlled temperature, pH, metal concentration, and time of addition, set in function of the metals involved, until a formation occurs, and in some cases occurs the age of a precipitate;
b) adjusting, in some cases, the pH of the reaction medium for the action of an inorganic acid or basic agent, added to the reaction medium in order to accelerate the co-precipitation stage;
c) filtering and/or centrifuging the precipitate in order to obtain a moist paste that provides conditions for molding;
d) peptize and redisperse the solid in an acid or basic agent so as to obtain a suspension with binding properties;
e) eliminate the excess of moisture from the solid obtained and form it in accordance with the selected technique, preferably by extrusion;
f) dry and calcine the formatted solid, according to the selected temperature programming, set in function of the metals present in the precursor, in order to obtain a mixed metal oxide to carburized, nitrided, or sulfonated;
g) expose the mixed metal oxide to a treatment stream that takes it to be formed into a molded mixed carbide, a molded mixed nitride, or a molded mixed sulfide; and
h) store molded carbides and nitrides in an organic compound that is liquid or solid at room temperature.

2. Process to prepare mixed molded precursor material to obtain carbides, nitrides, and sulfides in accordance with claim 1, wherein the metal is selected from among molybdenum, tungsten, niobium, and nickel.

3. Process to prepare mixed molded precursor material to obtain carbides, nitrides, and sulfides in accordance with claim 1, wherein the inorganic compounds precursors of the oxides are selected from among salts of nitrate, chloride, carbonate, phosphate, sulfate, or oxalate salts of the selected metals.

4. Process to prepare mixed molded precursor material to obtain carbides, nitrides, and sulfides in accordance with claim 1, wherein metal oxide precursor comprise compounds where the metal is in the form of an anionic complex, such as, molybdates, niobates or chromates.

5. Process to prepare mixed molded precursor material to obtain carbides, nitrides, and sulfides in accordance with claim 1, wherein the solutions be mixed by stirring, under controlled conditions of temperature and pH, time of the addition of the solutions, are set as a function of the metals involved, in order to promote the formation of a precipitate, or a suspension of the precursor solids for the multi-metal oxides desired, preferably in the form of an inorganic gel.

6. Process to prepare mixed molded precursor material to obtain carbides, nitrides, and sulfides in accordance with claim 1, wherein the pH in the reaction medium, after mixing the precursor solutions containing the metals, is adjusted by adding an acid or basic agent, to favor the phenomenon of co-precipitation of the multi-metal compound.

7. Process to prepare mixed molded precursor material to obtain carbides, nitrides, and sulfides in accordance with claim 1, wherein the suspension obtained be kept under stirring, for a period of some minutes up to 24 hours, preferably for some minutes up to 2 hours, at a temperature close to 5° C. and the suspension pH controlled, being the pair Mo—Nb preferably within the range of 2.8 and 3.3.

8. Process to prepare mixed molded precursor material to obtain carbides, nitrides, and sulfides in accordance with claim 1, wherein the dispersal agent is selected from H₂O, HNO₃, NH₄OH and acetic acid.

9. Process to prepare mixed molded precursor material to obtain carbides, nitrides, and sulfides in accordance with claim 1, characterized by a paste to be formatted and dried in the presence of air, at a temperature between 40 and 300° C., preferably between 40 and 150° C.

10. Process to prepare mixed molded precursor material to obtain carbides, nitrides, and sulfides in accordance with claim 1, characterized by the dry material possess an amorphous crystalline structure by X-Ray Diffraction.

11. Process to prepare mixed molded precursor material to obtain carbides, nitrides, and sulfides in accordance to claim 1, characterized by the dry material be calcined by air, under a programmed temperature, defined in function of the metals present in the precursor, within a range between 100° C. and 1000° C., preferably between 200° C. and 700° C.

12. Process to prepare mixed molded precursor material to obtain carbides, nitrides, and sulfides in accordance with claim 1, characterized by the material obtained be ready to be used as a catalyst, catalyst support, catalyst precursor, adsorbent or inert filler for the reactor or column.

13. Process to prepare mixed molded precursor material to obtain carbides, ntrides, and sulfides in accordance with claim 1, characterized by the solid material to be carburized, to form the respective metal carbide, or nitrided, to obtain the respective metal nitride, or sulfided, to obtain the corresponding sulfide.

14. Process to prepare mixed molded precursor material to obtain carbides, nitrides, and sulfides in accordance with claim 13, characterized by the solid material be submitted to a carburization reaction with a carbon precursor, in a reducing atmosphere, using as a source of carbon, hydrocarbons, preferably an alkane, and more specifically, methane, cycloalkanes or oil streams.

15. Process to prepare mixed molded precursor material to obtain carbides, nitrides, and sulfides in accordance with claim 13, characterized by the solid material submitted to a nitrided reaction, using ammonia as a source for nitrogen.

16. Process to prepare mixed molded precursor material to obtain carbides, nitrides, and sulfides in accordance with claim 13, characterized by the material submitted to a sulfited reaction, using hydrogen sulfide as a source for sulfur.

17. Process to prepare mixed molded precursor material to obtain carbides, nitrides, and sulfides in accordance with claim 14, wherein the solid material, carbide or nitride, newly synthesized collected in a liquid organic compound selected from the paraffin, isoparaffin, cycloparaffin, aromatic, polyaromatic classes, or combinations of these functions.

18. Process to prepare mixed molded precursor material to obtain carbides, nitrides, and sulfides in accordance with claim 1, characterized by the solid material obtained being suitable for use as catalysts in hydroprocessing reactions, such as the removal of organic sulfurized compounds, removal of organic nitrogenized compounds, removal of unsaturated and aromatic compounds, and the conversion of heavy compounds in lighter fractions applied, preferably, to hydrocarbon streams within the following range: Naphta, kerosene, gas-oils, heavy and waste gas-oils.

19. Process to prepare mixed molded precursor material to obtain carbides, nitrides, and sulfides in accordance with claim 14, characterized by using solid material, carbide or nitride, immersed in a protective solvent, having a catalyst in the reactional crucible together with the hydrocarbon stream load, when at that time the solvent is removed, heating in the presence of hydrogen or inert gas stream.
